(19) United States
(12) Patent Application Publication
(10) Pub. No.: US 2018/0170057 A1
(43) Pub. Date: Jun. 21, 2018

(54) METHOD FOR PRODUCING FLOW PATH MEMBER, METHOD FOR PRODUCING LIQUID EJECTING HEAD, AND METHOD FOR PRODUCING LIQUID CONTAINER

(71) Applicant: SEIKO EPSON CORPORATION, Tokyo (JP)

(72) Inventors: Ichiro AOYAMA, Shiojiri (JP); Jiro SHIOZAKI, Shiojiri (JP); Shuhei IWAOKA, Suwa (JP); Keiichi KOBAYASHI, Shiojiri (JP)

(21) Appl. No.: 15/839,461

(22) Filed: Dec. 12, 2017

(30) Foreign Application Priority Data
Dec. 15, 2016 (JP) 2016-243015

(51) Int. Cl. B41J 2/16; B23K 26/38; B23K 26/00; B23K 37/047; B23K 26/16

(52) U.S. Cl. CPC B41J 2/1634; B23K 26/38; B23K 26/16; B23K 37/047; B23K 26/0063

(57) ABSTRACT

A method for producing a flow path member including a laser processing step for forming the flow path member by laser processing by cutting a base plate, the laser processing step includes: a first cutting step for cutting a region to be formed as the flow path member by laser processing without separating the region from the base plate; and a second cutting step for cutting the region to be formed as the flow path member by laser processing to separate the region from the base plate, wherein the first cutting step is performed while the region to be formed as the flow path member is not supported, and the second cutting step is performed while the region to be formed as the flow path member is supported.

### BACKGROUND

### 1. Technical Field

The present invention relates to methods for producing a flow path member from a base plate which includes a gap forming member having continuous gaps, methods for producing a liquid ejecting head, and methods for producing a liquid container.

### 2. Related Art

As disclosed in JP-A-2015-217572 and JP-A-2014-034136, liquid ejecting heads and liquid containers are provided with a flow path member formed by a gap forming member in which gaps communicate with each other, which serves as a filter or foam for removing air bubbles or foreign substances contained in liquid.

Such a flow path member used in liquid ejecting heads and liquid containers is produced, for example, by pressing a gap forming member and separating into predetermined shapes.

However, cutting the gap forming member by press work causes deformation of the flow path member due to stress applied during the press work. Deformation of the flow path member raises a problem that the size of gaps are reduced and pressure loss during liquid flow through the flow path member increases. In particular, when the flow path member is produced by press punching a plate-shaped gap forming member, the number of times that the gap forming member is pressed between a die plate of the die and a stripper used for the press work varies depending on the positions in the gap forming member. Accordingly, the degree of deformation of the gaps varies depending on the positions in the gap forming member, leading to variation in pressure loss among a plurality of flow path members.

On the other hand, if a force by which the gap forming member is pressed between the die plate and the stripper during press work is reduced, the material is pulled into a cavity of the die and the outline is cut as if torn, leading to a problem that the external dimensional accuracy decreases.

Alternatively, cutting a gap forming member by laser processing is also possible. However, a residue or dross generated during laser processing contaminates inside the apparatus, particularly, on a surface of the table that holds the gap forming member, leading to a problem that the production efficiency decreases due to the requirement of regular cleanings.

These problems are not limited to the flow path member used for liquid ejecting heads or liquid containers, and are also present in the flow path member used for other devices.

### SUMMARY

An advantage of some aspects of the invention is that a method for producing a flow path member with an improved production efficiency by improving an external dimensional accuracy and reducing deformation, a method for producing a liquid ejecting head, and a method for producing a liquid container are provided.

According to an aspect of the invention, a method for producing a flow path member including a laser processing step for forming the flow path member by laser processing by cutting a gap forming member which is formed to allow gaps to communicate each other, the laser processing step comprising: a first cutting step for cutting the gap forming member by laser processing without separating a region to be formed as the flow path member; and a second cutting step for cutting the gap forming member by laser processing to separate the region to be formed as the flow path member, wherein the gap forming member is cut in the air in the first cutting step, and the gap forming member is cut while the region to be formed as the flow path member in the gap forming member is supported in the second cutting step.

In this aspect, the flow path member is produced by laser processing. Accordingly, deformation and variation in gap characteristics can be reduced and the external dimensional accuracy can be improved compared with production by press work.

Further, since the first cutting step is performed in the air, adhesion of dross generated in laser processing to a support member and the like can be reduced. Moreover, since the second cutting step is performed after cutting is performed by the first cutting step, head dissipation can be reduced, thereby reducing deformation due to heat.

A cutting length by cutting in the second cutting step is preferably smaller than a cutting length by cutting in the first cutting step. Accordingly, adhesion of dross to a support member for the gap forming member can be further reduced.

Further, laser output in the second cutting step is preferably smaller than laser output in the first cutting step. Accordingly, adhesion of dross to a support member for the gap forming member can be further reduced.

Further, it is preferred that cutting in the first cutting step and the second cutting step is each performed by a plurality of times of laser irradiation, and the number of times of laser irradiation in the second cutting step is larger than the number of times of laser irradiation in the first cutting step. Accordingly, since cutting in the first cutting step and the second cutting step is each performed by a plurality of times of laser irradiation, laser output in the first cutting step and the second cutting step can be decreased, thereby preventing a portion other than the region to be cut from being excessively heated. Further, laser output in the second cutting step can be decreased by increasing the number of times of irradiation in the second cutting step. Accordingly, excessive heating in the second cutting step can be reduced, thereby reducing generation of dross and deformation.

Further, it is preferred that cutting in the second cutting step is performed by a plurality of times of laser irradiation and that the output of (N+1)th laser irradiation is lower than the output of Nth laser irradiation in the second cutting step. Accordingly, since the laser output gradually decreases, the amount of heat decreases as cutting of the base plate 100 proceeds. As a result, heat dissipation is promoted to thereby reduce generation of excessive dross.

Further, it is preferred that cutting in the first cutting step is performed by a plurality of times of laser irradiation and that the output of (N+1)th laser irradiation is lower than the output of Nth laser irradiation in the first cutting step. Accordingly, since the laser output gradually decreases, the amount of heat decreases as cutting of the base plate 100 proceeds. As a result, heat dissipation is promoted to thereby reduce generation of excessive dross.

According to another aspect of the invention, a method for producing a liquid ejecting head includes the method for producing a flow path member of the above aspect.

In this aspect, a liquid ejecting head having a flow path member with reduced deformation and improved external dimensional accuracy can be produced.

According to still another aspect of the invention, a method for producing a liquid container includes the method for producing a flow path member of the above aspect.

In this aspect, a liquid container having a flow path member with reduced deformation and improved external dimensional accuracy can be produced.

### BRIEF DESCRIPTION OF THE DRAWINGS

The invention will be described with reference to the accompanying drawings, wherein like numbers reference like elements.

FIG. 1 is a diagram that illustrates a laser processing apparatus.

FIG. 2 is a diagram of the laser processing apparatus, illustrating a method for producing a flow path member.

FIG. 3 is a diagram of a gap forming member, illustrating a method for producing the flow path member.

FIG. 4 is a diagram of the laser processing apparatus, illustrating a method for producing the flow path member.

FIG. 5 is a diagram of the gap forming member, illustrating a method for producing the flow path member.

FIG. 6 is a diagram of the laser processing apparatus, illustrating a method for producing the flow path member.

FIG. 7 is an exploded perspective view of a recording head.

FIG. 8 is a cross-sectional view of an essential part of the recording head.

FIG. 9 is a cross-sectional view of a liquid container.

FIG. 10 is a diagram that illustrates another example of the flow path member.

FIG. 11 is a diagram that illustrates another example of the flow path member.

FIG. 12 is a diagram that illustrates a modified example of the laser processing apparatus.

### DESCRIPTION OF EXEMPLARY EMBODIMENTS

The invention will be described in detail with reference to an embodiment.

### Embodiment 1

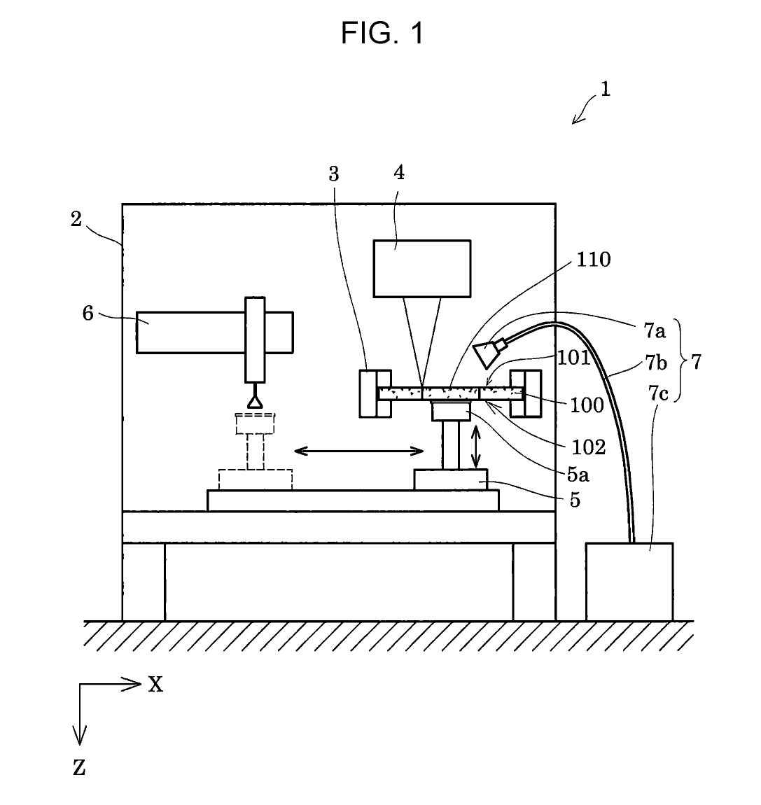

FIG. 1 is a schematic configuration view of a laser processing apparatus according to Embodiment 1 of the invention. As shown in the figure, the laser processing apparatus 1 is mounted on an apparatus main body 2 and includes a holding section 3 that holds a base plate 100 which includes a gap forming member which is formed to allow the gaps to communicate each other.

The base plate 100 is a plate member which includes a gap forming member which is formed to allow the gaps to communicate each other. Further, the base plate 100 which includes the gap forming member refers to both the base plate having the gap forming member formed over the entire surface and the base plate having the gap forming member formed on part of the surface. In other words, the base plate 100 may be made up of solely the gap forming member, and the base plate 100 may include a portion in which a gap forming member is formed and a portion in which gaps are not formed or gaps do not communicate each other. Since this embodiment uses the base plate 100 having the gap forming member formed over the entire surface, the base plate 100 hereinafter refers to a gap forming member. Examples of the base plate 100 (gap forming member) include, for example, foam (sponge) formed by continuously foaming a rubber or resin, and a sheet having a plurality of gaps formed by finely weaving or braiding fibers of metal, resin, or the like.

The holding section 3 holds the ends of the plate-shaped base plate 100 so as to expose a front surface 101 which is one surface of the base plate 100 and a rear surface 102 which is the other surface.

A laser irradiation unit 4 is disposed to irradiate a laser beam on the front surface 101 of the base plate 100 which is held by the holding section 3. Although the laser beam irradiate by the laser irradiation unit is not specifically limited, a CO₂ laser beam is used in the present embodiment. Further, although the laser irradiation unit 4 in the present embodiment irradiates a laser beam only on the front surface 101 of the base plate 100, the laser irradiation unit 4 is not limited thereto, and may irradiate a laser beam only on the rear surface 102 or may irradiate a laser beam on both the front surface 101 and the rear surface 102. Moreover, the surface on which a laser beam is irradiated may be different in a first cutting step and a second cutting step for cutting out a flow path member 110 from the base plate 100 by laser processing, which will be described later.

The support section 5 is disposed on the rear surface 102 of the base plate 100 held by the holding section 3 so as to support the rear surface 102 of the base plate 100 by the distal end of the support section 5. The base plate 100 is held by the support section 5 in any manner, and may be held, for example, by vacuum suctioning. That is, although not shown in the figure, a suction port for suctioning is provided on a surface of the support section 5 which faces the base plate 100 so that the base plate 100 is suctioned to a distal end 5a of the support section 5 by suctioning via the suction port by using a vacuum pump.

The distal end 5a that holds the base plate 100 of the support section 5 is movable in the Z direction which is a thickness direction of the base plate 100.

Further, the support section 5 is movable between a position in which it faces the rear surface 102 of the base plate 100 in the Z direction and a position in which it does not faces rear surface 102 of the base plate 100 in the Z direction. In the present embodiment, the moving direction of the support section 5 is referred to as the X direction.

The support section 5 moves to the position in which it faces the rear surface 102 of the base plate 100 in the Z direction at a predetermined timing during laser processing to support the rear surface 102 of the base plate 100.

Further, after cutting out the flow path member 110 from the base plate 100 by laser processing, the support section 5 moves to the position in which it does not faces rear surface 102 of the base plate 100 in the Z direction while supporting the flow path member 110 at the distal end 5a, and transfers the flow path member 110 to a pick-up unit 6.

Further, the apparatus main body 2 includes a dust collecting unit 7. The dust collecting unit 7 includes a nozzle 7a having a distal end disposed at a position which faces the front surface 101 of the base plate 100 held by the holding section 3, and a dust collector 7c which is connected to the nozzle 7a via a dust collecting tube 7b such as a rubber tube. The dust collecting unit 7 collects dust and smoke via the nozzle 7a, which are generated by irradiating a laser beam to the base plate 100 from the laser irradiation unit 4.

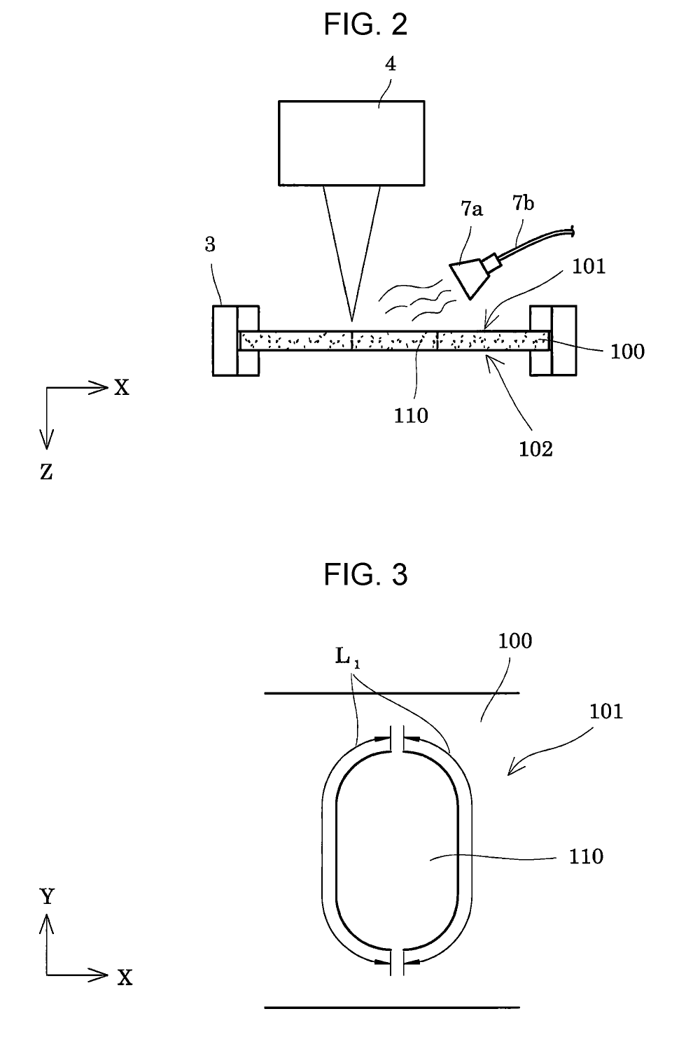

The flow path member 110 is formed by cutting the base plate 100 by a laser beam from the aforementioned laser processing apparatus 1. Here, with reference to FIGS. 2 to 6, a method for producing the flow path member 110 by using the laser processing apparatus 1 of the present embodiment will be described. FIGS. 2, 4 and 6 are diagrams of the laser processing apparatus for illustrating a method for producing the flow path member, and FIGS. 3 and 5 are diagrams of the gap forming member illustrating a method for producing the flow path member.

First, as shown in FIG. 2, the first cutting step is performed in which a laser beam is irradiated from the laser irradiation unit 4 onto the front surface 101 of the plate-shaped base plate 100 held by the holding section 3 to cut a region to be formed as the flow path member 110 without separating the region from the base plate 100. Further, in the first cutting step, the base plate 100 is cut in the air.

In the first cutting step, as shown in FIG. 3, the flow path member 110 is not completely separated from the base plate 100. The phrase “the flow path member 110 is cut from the base plate 100 without being completely separated” as used herein means that the outer shape of the flow path member 110 is not entirely cut off but is partially cut off. In the present embodiment, a substantial portion of the outline of the flow path member 110 is cut as the first cutting region so that a small portion on both ends in the Y direction, which is perpendicular to both the X direction and the Z direction, remains connected to the base plate 100. In the present embodiment, an oblong shape is cut out as the flow path member 110.

Further, as shown in FIG. 2, the base plate 100 is cut in the air in the first cutting step. The phrase “the base plate 100 is cut in the air” as used herein means that a portion of the front surface 101 and the rear surface 102 of the base plate 100 in which a laser beam is irradiated and its surrounding area are not supported by the support section 5. In the present embodiment, the base plate 100 with the end portions held by the holding section 3 is cut while not being supported or held by the support section 5.

As described above, since the base plate 100 held by the holding section 3 and a portion to be formed as the flow path member 110 are connected to each other in the first cutting step, the portion to be formed as the flow path member 110 does not fall off from the base plate 100 when cut in the air.

Further, smoke and dust generated by cutting the base plate 100 in the first cutting step are collected by the dust collecting unit 7. Accordingly, in the first cutting step, adhesion of the residue (dross) generated by cutting the base plate 100 to the support section 5 can be reduced. Further, in the first cutting step, the support section 5 may be located at the position in which it faces the rear surface 102 of the base plate 100 in the Z direction with a gap formed between the distal end 5a and the rear surface 102, or may have moved to the position in which it does not face the rear surface 102 of the base plate 100 in the Z direction, that is, it transfers the flow path member 110 to the pick-up unit 6.

Moreover, the aforementioned first cutting step can be performed by repeating a plurality of times of laser irradiation. Since this allows for cutting by a laser beam of small output power, the region of the base plate 100 which is melt by a laser beam can be reduced to thereby reduce the generation of dross.

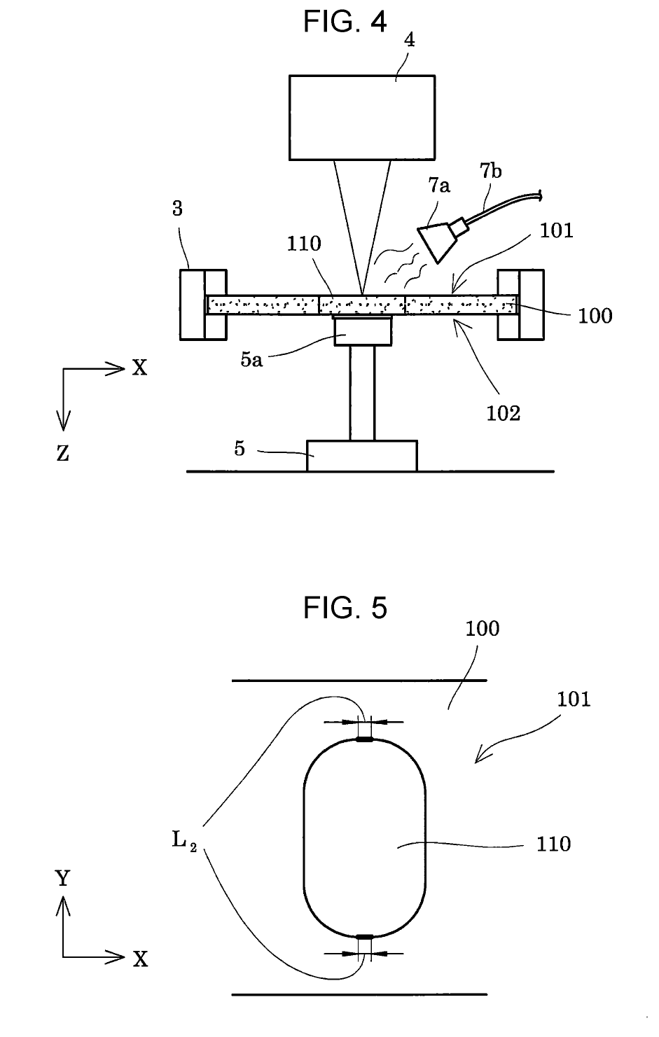

Then, as shown in FIGS. 4 and 5, while the region to be formed as the flow path member 110, which is cut in the first cutting step, is supported by the distal end 5a of the support section 5 from the rear surface 102, the second cutting step for cutting off the flow path member 110 is performed. That is, the second cutting step is performed to cut the portion of the outline of the flow path member 110 which remains connected to the base plate 100 without being cut off in the first cutting step of the flow path member 110 so that the flow path member 110 is separated from the base plate 100.

The distal end 5a of the support section 5 has an area smaller than that of the region to be formed as the flow path member 110. Accordingly, when the base plate 100 is cut by a laser beam while the support section 5 holds the region to be formed as the flow path member 110, dross generated during cutting is not likely to be adhered to the support section 5.

Further, since the distal end 5a of the support section 5 has an area smaller than that of the flow path member 110, it is also possible to perform the first cutting step and the second cutting step while the support section 5 supports the flow path member 110. However, if the support section 5 supports the base plate 100 when the first cutting step is performed, dross during the cutting is adhered to the support section 5. Particularly, in the present embodiment, since the support section 5 holds the base plate 100 by suctioning, dross generated during cutting in the first cutting step is likely to be suctioned by the support section 5 to cause the dross to be adhered on and inside the support section 5. Since the first cutting step in this embodiment is performed in the air without supporting the base plate 100 by the support section 5, adhesion of the dross generated in the first cutting step to the support section 5 can be reduced. Further, although the dross generated in the second cutting step is adhered to the support section 5, the amount of dross generated in the second cutting step is smaller than the total amount of dross generated in the first cutting step and the second cutting step. Further, smoke and dust generated by cutting the base plate 100 in the first cutting step are readily collected by the dust collecting unit 7 since they do not adhere to the support section 5. This also contributes to reducing dross contamination in the apparatus main body 2. Accordingly, reducing the amount of dross adhered to the support section 5 and the apparatus main body 2 can extend the interval for removing the dross adhered to the support section 5 and the apparatus main body 2 and reduce the frequency of cleaning to thereby improve the producing efficiency.

As shown in FIG. 5, in the second cutting step, part of the base plate 100 has been cut by the first cutting step. Accordingly, heat by the laser beam is not likely to be dissipated. As a result, in the second cutting step, since heat is concentrated on a portion connecting the base plate 100 and the flow path member 110 by reducing heat dissipation, the amount of dross generated can be reduced.

Further, as with the first cutting step, the second cutting step is performed while smoke and dust generated are collected by the dust collecting unit 7. As described above, the dross generated in the second cutting step is more likely not to be adhered to the support section 5 since the amount of smoke and dust generated in the second cutting step is reduced and the cutting is performed while the smoke and dust is collected by the dust collecting unit 7.

Moreover, as with the first cutting step, the second cutting step can also be performed by repeating a plurality of times of laser irradiation. Since this allows for cutting by a laser beam of small output power, the region of the base plate 100 which is melt by a laser beam can be reduced to thereby reduce the generation of dross.

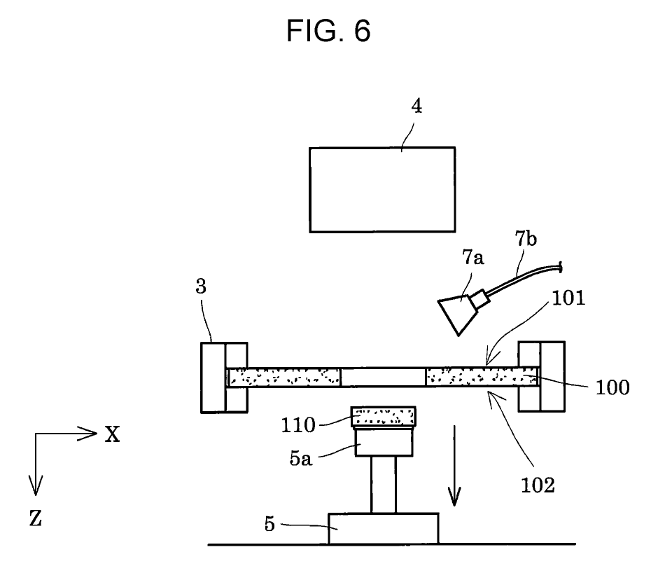

The flow path member 110 thus completely separated from the base plate 100 by the second cutting step does not fall since it is held by the support section 5 as shown in FIG. 6. The flow path member 110 separated is moved in the X direction by the support section 5, and is transferred to the pick-up unit 6.

As described above, in the laser processing step of the present embodiment, the first cutting step is performed for cutting the flow path member 110 in the base plate 100 without separating from the base plate 100 by performing laser processing in the air, and the second cutting step is performed for cutting off the flow path member 110 from the base plate 100 while the support section 5 holds the region to be formed as the flow path member 110. Accordingly, adhesion of the dross generated during cutting the base plate 100 to the support section 5 can be reduced. Further, in the second cutting step, since part of the base plate 100 has been cut by the first cutting step, heat by the laser beam is not likely to be dissipated, and generation of dross can be reduced. In addition, compared with a case where the flow path member 110 is separated from the base plate 100 by press work, variation in the degree of deformation of the gap depending on positions on the base plate 100 can be reduced, thereby reducing variation in pressure loss among a plurality of flow path members 110. That is, the flow path members 110 with less variation in pressure loss can be produced.

In the present embodiment, as shown in FIGS. 3 and 5, a cutting length L₂ of cutting the base plate 100 in the second cutting step is preferably smaller than a cutting length L₁ of cutting the base plate 100 in the first cutting step. Thus, when the cutting length L₂ by cutting in the second cutting step is set to be smaller than the cutting length L₁ by cutting in the first cutting step, the amount of dross generated by the second cutting step can be reduced, thereby reducing adhesion of the dross to the support section 5. Moreover, the cutting length L₂ by cutting the base plate 100 in the second cutting step may be an extent that does not cause the flow path member 110 to fall from the base plate 100. Further, the cutting length L₁ by cutting the base plate 100 in the first cutting step is preferably as long as possible, and the cutting length L₂ by cutting the base plate 100 in the second cutting step is preferably as short as possible. This contributes to reducing dross adhesion to the support section 5 and the apparatus main body 2.

Further, laser output in the second cutting step is preferably smaller than laser output in the first cutting step. Thus, when the laser output in the second cutting step is set to be smaller than the laser output in the first cutting step, dross generation in the second cutting step can be reduced to thereby reduce adhesion of dross to the support section 5. Further, when the laser output in the first cutting step is set to be larger than the laser output in the second cutting step, the cutting length by cutting in the first cutting step can be increased and the period of time required for cutting can be decreased.

Moreover, in the present embodiment, cutting in the first cutting step and the second cutting step is performed by a plurality of times of laser irradiation. As a result, laser output in the first cutting step and the second cutting step can be reduced compared with cutting by one irradiation of a laser beam. Therefore, change in characteristics due to cutting can be reduced compared with a case of cutting by one irradiation of a laser beam. That is, if the base plate 100 is cut by one irradiation of a laser beam, high output is required for a laser beam and thus the amount of heat increases. As a result, a surrounding area of the portion of the base plate 100 to be cut is also melt, which changes the state of gaps and changes the pressure loss and the like. According to the present embodiment, cutting in the first cutting step and the second cutting step is performed by a plurality of times of laser irradiation. As a result, it is possible to reduce an output for one irradiation of a laser beam, prevent a surrounding area of the portion to be cut from being melt, improve the accuracy, and increase the production yield. That is, the laser output in the first cutting step and the second cutting step can be decreased with the increase of the number of times of laser irradiation.

Further, when the laser output in the second cutting step is smaller than the laser output in the first cutting step, the number of times of laser irradiation in the second cutting step is preferably larger than the number of times of laser irradiation in the first cutting step. That is, since the laser output in the second cutting step is decreased, cutting can be reliably performed by increasing the number of times of laser irradiation.

Further, when cutting in the first cutting step is performed by a plurality of times of laser irradiation, it is preferred that the output of (N+1)th laser irradiation is lower than the output of Nth laser irradiation in the first cutting step. That is, it is preferred that the laser output is gradually decreased as the laser irradiation is repeatedly performed. Thus, since the laser output gradually decreases, the amount of heat decreases as cutting of the base plate 100 proceeds. Accordingly, heat dissipation is promoted to thereby reduce generation of excessive dross.

Likewise, when cutting in the second cutting step is performed by a plurality of times of laser irradiation, it is preferred that the output of (N+1)th laser irradiation is lower than the output of Nth laser irradiation in the second cutting step. That is, it is preferred that the laser output is gradually decreased as the laser irradiation is repeatedly performed. Thus, since the laser output gradually decreases, the amount of heat decreases as cutting of the base plate 100 proceeds. Accordingly, heat dissipation is promoted to thereby reduce generation of excessive dross.

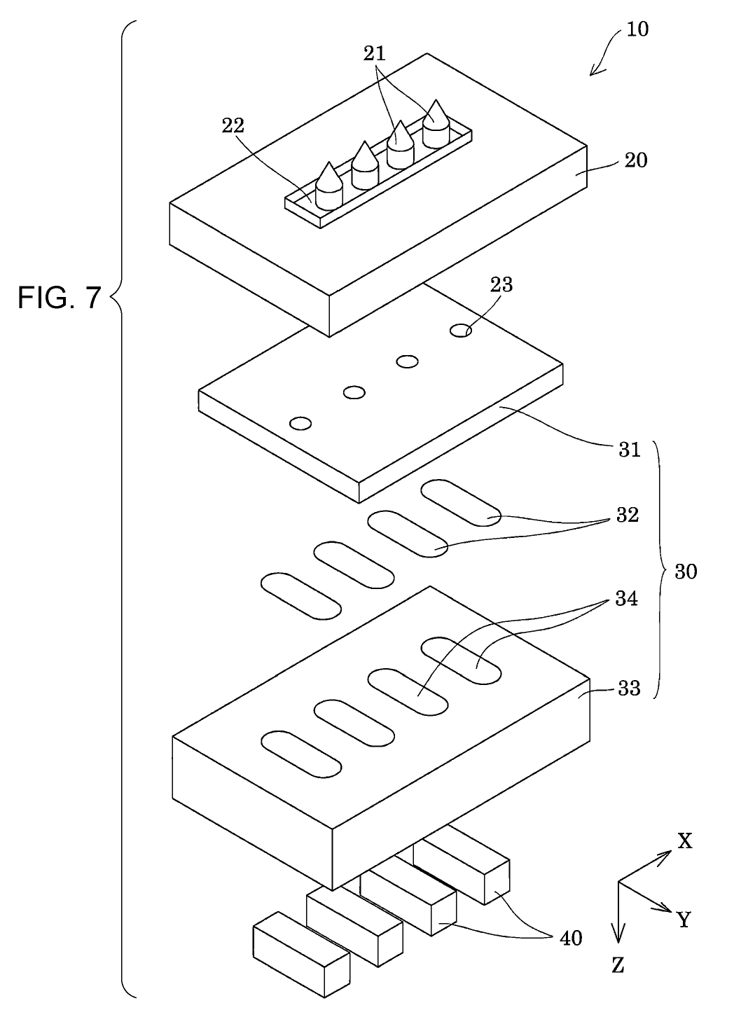

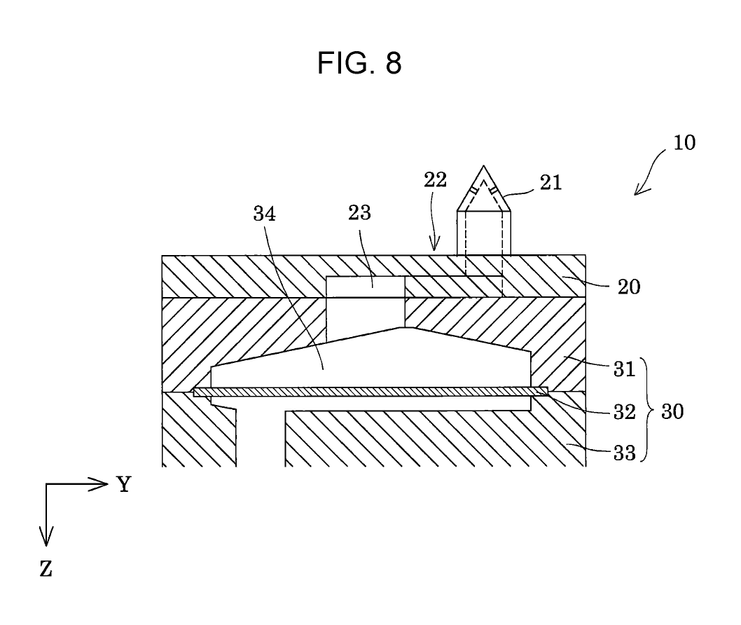

With reference to FIGS. 7 and 8, an ink jet recording head which is an example of the liquid ejecting head that uses the flow path member 110 will be described. Further, FIG. 7 is an exploded perspective view of an ink jet recording head which is an example of the liquid ejecting head, and FIG. 8 is a cross-sectional view of an essential part of the ink jet recording head.

As shown in FIG. 7, an ink jet recording head 10 which is an example of the liquid ejecting head of the present embodiment includes a holder 20 on which a plurality of ink introduction needles 21 are formed, a flow path unit 30, and a plurality of head main bodies 40.

The holder 20 has a cartridge mounting section 22 on one surface such that the ink cartridge is detachably mounted thereon. The plurality of ink introduction needles 21 stand on the cartridge mounting section 22. In the present embodiment, four ink introduction needles 21 are provided for each of the ink cartridges that supply ink to four head main bodies 40.

Further, as shown in FIG. 8, holder flow paths 23 that supply ink introduced from the ink introduction needles 21 to the flow path unit 30 is disposed in the holder 20.

In this embodiment, the ink introduction needles 21 are disposed in the holder 20. However, the invention is not specifically limited thereto, and for example, a filter connected to a filter of the ink cartridge at a liquid surface may be disposed in the holder 20.

The flow path unit 30 includes a first flow path unit 31 that is mounted on the holder 20, and a second flow path unit 33 mounted on the surface of the first flow path unit 31 opposite to the holder 20 with filters 32 which are flow path members interposed therebetween.

Flow paths 34 that communicate with the holder flow paths 23 are disposed in the flow path unit 30. The flow path 34 is provided with a filter 32 that traverses the flow path 34. The filter 32 is provided for catching foreign substances such as air bubbles and dust contained in ink, and is made up of the flow path member 110 formed by cutting out from the plate-shaped gap forming member having continuous gaps. For example, if the flow path member 110 which serves as the filter 32 is formed by press punching the base plate 100, deformation of the filter 32 occurs due to stress applied during the press work. Further, deformation of the filter 32 decreases the size of the gap, leading to increase in pressure loss of the filter 32. In particular, when the plate-shaped base plate 100 is press punched, the number of times that the base plate 100 is pressed between a die plate of a die and a stripper used for the press work varies depending on the positions in the base plate 100. Accordingly, the degree of deformation of the gaps varies depending on the positions in the base plate 100, leading to variation in pressure loss. In addition, if a force by which the base plate 100 is pressed between the die plate and the stripper during press work is reduced, the material is pulled into a cavity of the die and the outline is cut as if torn, leading to a decrease in the external dimensional accuracy. In the present embodiment, the filter 32 produced by the above producing method of the flow path member can be used to prevent deformation of the filter 32 and thereby restrict an increase or variation in pressure loss. Further, since the external dimensional accuracy of the filter 32 can be improved, the filter 32 can be prevented from being displaced or disengaged when the filter 32 is assembled into the flow path unit 30.

Further, as shown in FIG. 7, a plurality of head main bodies 40 are fixed on the side of the flow path unit 30 opposite to the holder 20, that is, on the side of the second flow path unit 33 opposite to the first flow path unit 31.

Inside the head main body 40, which is not shown, a liquid flow path communicating with a flow path of the flow path unit 30 and having a pressure generating chamber, and a pressure generating means that generates pressure change in pressure in the pressure generating chamber are provided. Examples of pressure generating means include a thin film type actuator device having a piezoelectric material such as lead zirconate titanate (PZT) formed by film formation, lithographic method or the like, a thick film type actuator device formed by bonding a green sheet, and a vertical vibration type actuator device formed by alternately laminating a piezoelectric material and an electrode forming material so as expand and contract in the axial direction. Further, examples of pressure generating means also include a type that ejects liquid droplets from nozzles by means of bubbles generated by heat from a heat generating element disposed in the pressure generating chamber, and a so-called electrostatic actuator that deforms a vibration plate due to electrostatic force generated between the vibration plate and the electrode.

The head main body 40 includes a nozzle, not shown in the figure, that communicates with a liquid flow path on a surface opposite to the surface fixed to the flow path unit 30 so that ink droplets are ejected from the nozzle by generating pressure change in the pressure generating chamber by using the pressure generating means.

A method for producing the ink jet recording head 10 may include the aforementioned method for producing the flow path member.

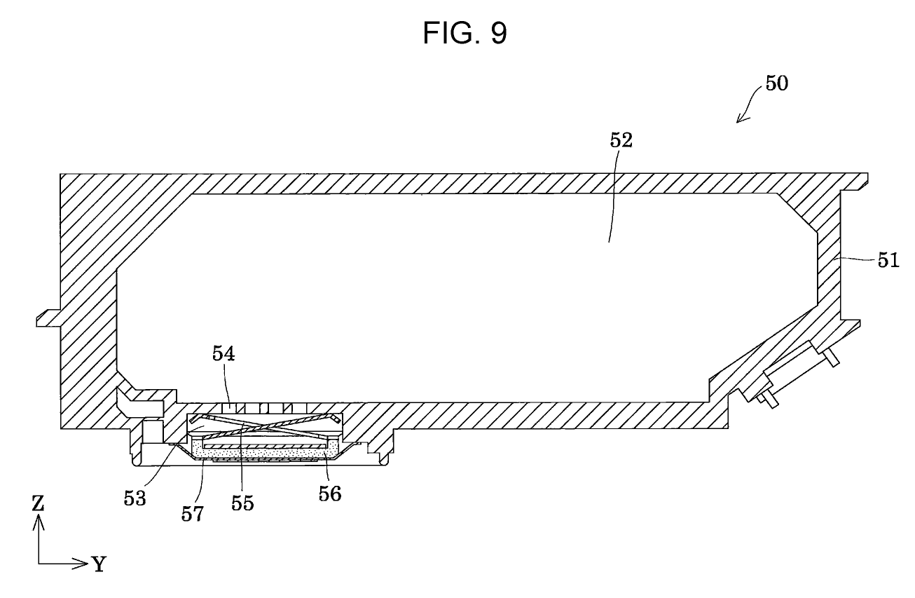

With reference to FIG. 9, an example of the liquid container which uses the flow path member 110 will be described. FIG. 9 is a cross-sectional view of a liquid container.

As shown in FIG. 9, a liquid container 50 includes a case 51, a liquid containing portion 52 formed in the case 51, and a liquid supplying portion 53 disposed on the bottom of the case 51.

The liquid containing portion 52 is disposed in the upper part of the case 51 and stores liquid such as ink.

The liquid supplying portion 53 communicates with the liquid containing portion 52 via a communication port 54. The liquid supplying portion 53 includes a leaf spring 55 provided close to the liquid containing portion 52, a foam 56 provided opposite to the communication port 54 with respect to the leaf spring 55, and a filter 57 provided opposite to the leaf spring 55 with respect to the foam 56.

The leaf spring 55 biases the foam 56 toward the filter 57. The bias member that biases the foam 56 toward the filter 57 is not limited to the leaf spring 55, and may be a coil spring, rubber or the like.

The foam 56 is a porous member, and allows ink supplied from the liquid containing portion 52 via the communication port 54 to be spread into a plane on the filter 57.

The filter 57 is provided for catching foreign substances such as air bubbles or dust contained in the ink supplied from the foam 56, and is disposed to cover an opening on the bottom of the liquid supplying portion 53.

In this liquid container 50, ink in the liquid containing portion 52 is supplied to the foam 56 via the communication port 54, and is spread in a plane on the filter 57 by the foam 56.

In the present embodiment, one or both of the foam 56 and the filter 57 provided in the liquid container 50 is the aforementioned flow path member 110. That is, a method for producing the liquid container 50 may include the aforementioned method for producing the flow path member.

Thus, one or both of the foam 56 and the filter 57 can be produced by the aforementioned producing method of the flow path member to thereby reduce deformation and achieve high accuracy.

### Other Embodiments

Although one embodiment of the invention has been described, the basic configuration of the invention is not limited to the above description.

For example, in the above-mentioned Embodiment 1, one flow path member 110 is cut off from the base plate 100 in the first cutting step and the second cutting step. However, the invention is not specifically limited thereto, and a plurality of flow path members may be concurrently produced in the first cutting step and the second cutting step.

Further, in the above-mentioned Embodiment 1, the base plate 100 made up of solely the gap forming member is described. However, the invention is not specifically limited thereto, and the base plate may include a portion in which the gap forming member is formed and a portion in which the gap forming member is not formed or a portion in which gaps are not continuous. Further, the first cutting step and the second cutting step in the above-mentioned Embodiment 1 may be performed not only to a portion in which the gap forming member of the base plate is formed, but also to the other portion of the base plate, that is, a portion in which the gap forming member is not formed or a portion in which gaps are not continuous. By performing the same first cutting step and the second cutting step as those of Embodiment 1 to the portion of the base plate other than the gap forming member, adhesion of the dross generated during cutting the base plate 100 to the support section 5 can also be reduced. Further, compared with a case where the flow path member 110 is separated from the base plate 100 by press work, variation in the degree of deformation of the gap depending on positions on the base plate 100 can be reduced, thereby reducing variation in pressure loss among a plurality of flow path members 110. This is because that a press work often causes deformation of the gap forming member or variation in the degree of deformation since the gap forming member of the base plate is pressed between the die plate of the die and the stripper even if the gap forming member is not the portion to be cut off.

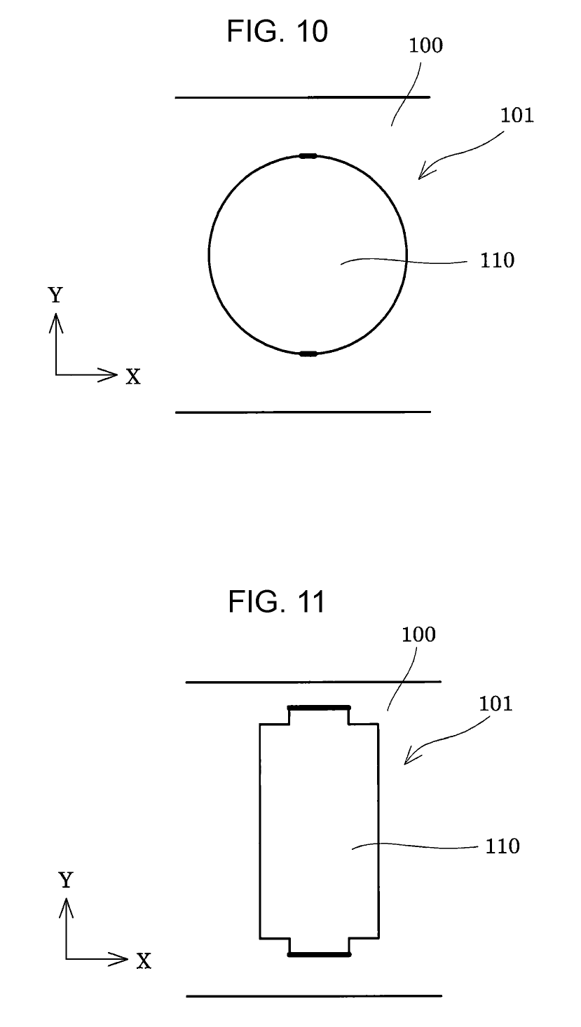

Further, in the above-mentioned Embodiment 1, an oblong flow path member 110 is described, but the shape of the flow path member 110 is not specifically limited thereto. FIGS. 10 and 11 show other examples of the flow path member. As shown in FIG. 10, the flow path member 110 may have a circular shape. Further, as shown in FIG. 11, the flow path member 110 may have a rectangular shape with corners notched. In FIGS. 10 and 11, a portion of the flow path member 110 to be cut by the first cutting step is indicated by a thin line, and a portion cut by the second cutting step is indicated by a thick line. However, a portion cut by the second cutting step is not limited thereto.

Further, for example, a portion of the thickness of the base plate 100 in the Z direction is cut by the first cutting step, and the remaining portion may be cut by the second cutting step so as to penetrate in the Z direction. That is, in the first cutting step, cutting the region to be formed as the flow path member 110 without separating the region from the base plate 100 refers to both cutting the outline of the flow path member 110 while remaining a portion of the outline uncut as shown in Embodiment 1 and cutting while remaining a portion in the Z direction uncut.

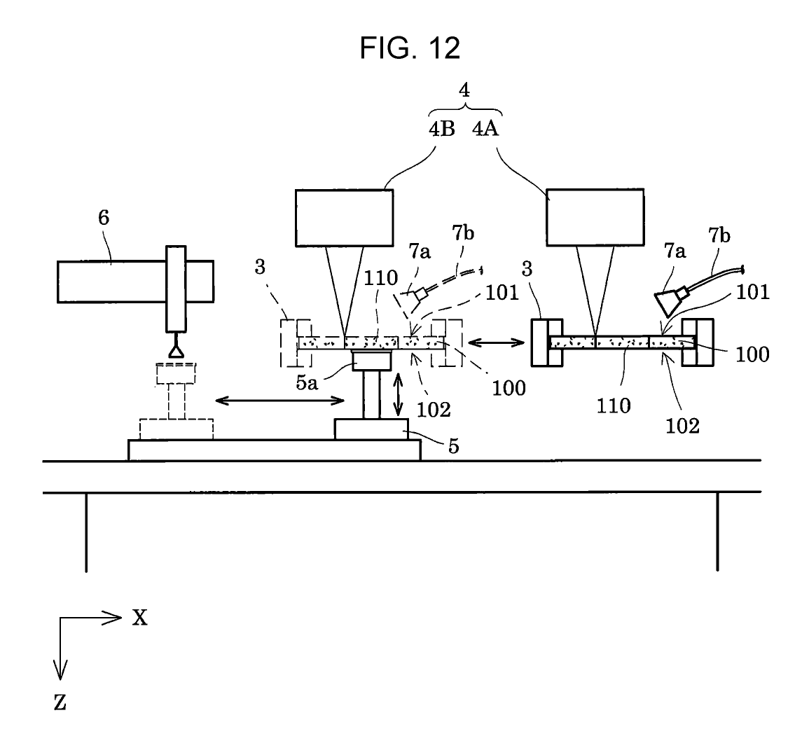

Further, in the above-mentioned Embodiment 1, the first cutting step and the second cutting step are performed by using the same laser irradiation unit 4. However, the invention is not limited thereto. FIG. 12 illustrates a modified example of the laser processing apparatus.

As shown in FIG. 12, the holding section 3 that constitutes the laser processing apparatus 1 is provided to be movable in the X direction. The laser irradiation unit 4 includes a first laser processing apparatus 4A and a second laser processing apparatus 4B arranged in the X direction.

In this laser processing apparatus 1, after the first cutting step is performed by the first laser processing apparatus 4A, the holding section 3 moves the base plate 100 in the X direction, and the second cutting step is then performed by the second laser processing apparatus 4B. That is, in the first cutting step, the support section 5 does not need to move in the X direction for standby. In this laser processing apparatus 1 as well, adhesion of dross to the support section 5 can be reduced, and deformation of the flow path member 110 can be reduced to thereby improve the external dimensional accuracy as with the above-mentioned Embodiment 1.

Further, in the examples shown in the above-mentioned Embodiment 1 and FIG. 12, the base plate 100 and the support section 5 are relatively moved in the X direction in the first cutting step. However, the invention is not specifically limited thereto, and for example, the support section 5 may be covered by a protective member when the first cutting step is performed. Further, a pan or the like may be provided so as to receive dross fallen at a position that faces the rear surface 102 of the base plate 100 when the support section 5 moves in the X direction. Further, the pan may hold an extinguishing agent such as water to prevent the occurrence of a fire.

Further, in the above-mentioned Embodiment 1, the flow path member that transmits liquid to be ejected such as ink therethrough. However, the invention is not specifically limited thereto, and the flow path member may be a filter or a foam that transmits other liquid than the liquid to be ejected or gas rather than liquid. That is, the flow path member of the present embodiment is any material that transmits a fluid such as liquid or gas.

Further, in the above-mentioned Embodiment 1, an ink jet recording head is described as an example of the liquid ejecting head. However, the invention widely covers the liquid ejecting head in general, and may be applied to liquid ejecting heads that eject liquid other than ink. Examples of other liquid ejecting heads include various recording heads used for image recording apparatuses such as a printer, color material ejection heads used for manufacturing color filters for liquid crystal displays and the like, electrode material ejection heads used for manufacturing electrodes for organic EL displays, field emission displays (FEDs) and the like, and bioorganic ejection heads used for manufacturing biochips.

Further, the invention is not limited to the flow path member used for the liquid ejecting head and the flow path member used for the liquid container, and may be applied to the flow path member used for other devices.

The entire disclosure of Japanese Patent Application No. 2016-243015, filed Dec. 15, 2016 is expressly incorporated by reference herein.

What is claimed is:

1. A method for producing a flow path member including a laser processing step for forming the flow path member by laser processing by cutting a base plate having a gap forming member which is formed to allow gaps to communicate each other, the laser processing step comprising:
a first cutting step for cutting a region to be formed as the flow path member by laser processing without separating the region from the base plate; and
a second cutting step for cutting the region to be formed as the flow path member by laser processing to separate the region from the base plate, wherein
the first cutting step is performed while the region to be formed as the flow path member in the base plate is not supported, and
the second cutting step is performed while the region to be formed as the flow path member in the base plate is supported.

2. The method for producing a flow path member according to claim 1, wherein a cutting length by cutting in the second cutting step is smaller than a cutting length by cutting in the first cutting step.

3. The method for producing a flow path member according to claim 1, wherein a laser output in the second cutting step is smaller than a laser output in the first cutting step.

4. The method for producing a flow path member according to claim 3, wherein
cutting in the first cutting step and the second cutting step is each performed by a plurality of times of laser irradiation, and
the number of times of laser irradiation in the second cutting step is larger than the number of times of laser irradiation in the first cutting step.

5. The method for producing a flow path member according to claim 1, wherein
cutting in the second cutting step is performed by a plurality of times of laser irradiation, and
an output of (N+1)th laser irradiation is lower than an output of Nth laser irradiation in the second cutting step.

6. The method for producing a flow path member according to claim 1, wherein
cutting in the first cutting step is performed by a plurality of times of laser irradiation, and
an output of (N+1)th laser irradiation is lower than an output of Nth laser irradiation in the first cutting step.

7. A method for producing a liquid ejecting head comprising the method for producing a flow path member according to claim 1.

8. A method for producing a liquid container comprising the method for producing a flow path member according to claim 1.
